(19) United States
(12) Patent Application Publication
(10) Pub. No.: US 2012/0167057 A1
(43) Pub. Date: Jun. 28, 2012

(54) DYNAMIC INSTRUMENTATION OF SOFTWARE CODE

(75) Inventors: Christopher P. Schmich, Seattle, WA (US); Peter C. Huene, San Francisco, CA (US)

(73) Assignee: MICROSOFT CORPORATION, Redmond, WA (US)

(21) Appl. No.: 12/975,363

(22) Filed: Dec. 22, 2010

(51) Int. Cl. G06F 9/44

(52) U.S. Cl. 717/130

(57) ABSTRACT

A dynamic instrumentation system is described herein that performs dynamic, in-memory software code instrumentation achieved by injecting a library into the process to intercept module loads and instrument the methods in those modules with appropriate probes. The system instruments original methods to redirect execution to new methods to perform code verification tasks. By performing dynamic instrumentation, no binaries are modified on-disk, any existing code signing is preserved, and the locations from which the binaries are loaded do not matter. The system allows instrumentation to occur on any computing device, without pre-preparation by a tester or developer to install instrumented binaries. The system also does not involve gaining access to potentially sensitive locations on disk, as the binaries are modified in memory with the originals still unchanged on disk. Thus, the dynamic instrumentation system allows for more effective code analysis with less preparation and hassle for code developers.

### BACKGROUND

The software development process at its simplest level involves a software developer writing software code in a language (e.g., C++, C#, Assembly), and using tools such as compilers to build the code into binary executable modules. As software becomes more complex, multiple developers may work on a project and use tools that are more sophisticated such as check-in managers, centralized build systems, and so forth. A developer may also run one or more automated verification tools, such as unit tests, static code checkers, runtime code checkers, performance tools, code coverage tools, and so forth. Newer integrated development environments (IDEs), such as MICROSOFT™ VISUAL STUDIO™ attempt to inform developers as early as possible about potential code defects and provide tools for improving code quality at many phases of the development process.

Tools used to improve software code, such as code coverage tools and profiling tools, often involve the creation of instrumented binaries of an application program. The build process for an application produces one or more executable files (EXEs), dynamically linked libraries (DLLs), or other modules. To determine whether particular areas of the code have been run, typical tools modify the built modules to include instrumentation that logs information to a buffer or other location when a particular event occurs. For example, code coverage tools may modify each function and branch within functions of application code to include a call to increment a buffer associated with that code location. Such tools modify the files on disk to create new files that the developer then deploys and exercises in a test environment to capture code coverage, performance, or other information.

Static instrumentation occurs on-disk, typically during compilation or after the binary is linked. This approach is troublesome in many scenarios because it involves knowledge of where the binary is deployed. Additionally, write access is needed so the binary can be modified on-disk, any code signing present is invalidated, and a separate cleanup step is needed to ensure that the original binary is restored after code coverage data has been collected. Dealing with security can be difficult, as the user running the code coverage may not have access to modify files in sensitive locations of an operating system, such as the system32 folder of MICROSOFT™ WINDOWS™ or the global assembly cache (GAC) for MICROSOFT™ .NET applications. For dynamic binaries, such as those that are just in time (JIT) compiled slightly before execution, static instrumentation will not work at all as the binary is built well after any opportunity for instrumentation.

### SUMMARY

A dynamic instrumentation system is described herein that performs dynamic (runtime), in-memory software code instrumentation achieved by injecting a library into the process to intercept module loads and instrument the methods in those modules with appropriate probes. The system modifies original methods to redirect execution to cloned/instrumented methods that perform various instrumenting tasks. By performing dynamic instrumentation, no binaries are modified on-disk, any existing code signing is preserved, and the locations from which the binaries are loaded do not matter. The system allows instrumentation to occur on any computing device, without pre-preparation by a tester or developer to install instrumented binaries. The system also does not involve gaining access to potentially sensitive locations on disk, as the binaries are modified in memory with the originals still unchanged on disk. Moreover, a software company can request that customers or early adopters provide code coverage or other information without asking them to understand how to replace normal binaries with instrumented versions. In some embodiments, the system copies an original function, modifies the copy with instrumentation, and then redirects the original function to execute the modified copy. Thus, the dynamic instrumentation system allows for more effective code analysis with less preparation and hassle for code developers.

This Summary is provided to introduce a selection of concepts in a simplified form that are further described below in the Detailed Description, This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the dynamic instrumentation system, in one embodiment.

FIG. 2 is a flow diagram that illustrates processing of the dynamic instrumentation system to instrument an executable process dynamically within a runtime library running in the process, in one embodiment.

FIG. 3 is a flow diagram that illustrates processing of the dynamic instrumentation system to control a dynamic runtime injected in a process for instrumentation through a monitoring application, in one embodiment.

FIG. 4 is a block diagram that illustrates the instrumentation of software code for code coverage by the dynamic instrumentation system, in one embodiment.

### DETAILED DESCRIPTION

A dynamic instrumentation system is described herein that performs dynamic (runtime), in-memory software code instrumentation achieved by injecting a library into the process to intercept module loads and instrument the methods in those modules with appropriate probes. The system modifies original methods to redirect execution to cloned/instrumented methods that perform various instrumenting tasks. By performing dynamic instrumentation, no binaries are modified on-disk, any existing code signing is preserved, and the locations from which the binaries are loaded do not matter. The system allows instrumentation to occur without pre-preparation by a tester or developer to install instrumented binaries other than providing access to symbolic information. The system also does not involve gaining access to potentially sensitive locations on disk (or other type of persistent storage, such as solid-state storage), as the binaries are modified in memory with the originals still unchanged on disk. Moreover, a software company can request that customers or early adopters provide code coverage or other information without asking them to understand how to replace normal binaries with instrumented versions.

There have been other systems that dynamically modify processes, but these typically operate to modify the process behavior in some way. For example, MICROSOFT™ WINDOWS™ provides a shimming architecture that allows the operating system manufacturer or others to provide shims that allow applications that were designed fora prior operating system version to run correctly on a new operating system version by dynamically modifying runtime calls to deprecated or modified application programming interfaces (APIs). In contrast, the dynamic instrumentation system is typically targeted towards avoiding interrupting or changing the application's behavior. Rather, the dynamic instrumentation system seeks to monitor and collect information about normal application execution under a variety of conditions, and injects probing runtime code to do so. The system performs in-memory instrumentation at runtime for collecting code coverage information or other runtime statistics that involve instrumented code. In some embodiments, the system copies an original function, modifies the copy with instrumentation, and then redirects the original function to execute the modified copy. The system may also detect dynamically loaded code (e.g., via APIs like LoadLibrary or NtMapViewOfSection) to instrument and use exception handing information to identify additional code blocks that are not part of the function's main, contiguous body. Thus, the dynamic instrumentation system allows for more effective code analysis with less preparation and hassle for code developers.

The following is an overview of the dynamic instrumentation system's operation, in one embodiment. The system injects a runtime instrumentation library into the target process. For example, the system may include a DLL with functions for performing all of the instrumentation within the processes address space. The runtime library intercepts module loads or other useful calls. For example, the system can use API-hooking techniques to hook calls to module loading functions. When a module loads, the system enumerates the modules methods (e.g., using debug information). Then, the system disassembles each method. For example, the runtime library may include disassembler code. The system allocates memory to hold the instrumented versions of the enumerated methods. Because instrumentation increases code size, the original location of the module code is typically insufficient to hold the instrumentation. However, in some cases the system may keep some of the original code for use and call out to a probe method to perform additional processing. Next, the system emits an instrumented version of the method into the allocated memory. Finally, the system inserts a call (e.g., through an assembly jmp or other instruction) at the beginning of the original function to redirect to the instrumented method.

In order to do dynamic instrumentation, the runtime instrumentation library runs in the target process. A console or other monitoring application through which the developer controls the code testing process injects the runtime library into the target process. There are several methods to do this, but one is to start the target process in a suspended state and modify the import address table to include the runtime library as its first load-time dependency. The monitoring application then allows execution of the target process to resume, causing the runtime library to be loaded and initialized by the loader. During that process, the runtime library has an opportunity to perform initial processing (e.g., through DIIMain).

Once the runtime library is present in the target process, the library detects module loads by intercepting calls to operating system loading APIs. As the library detects calls to the loading APIs, the library enumerates methods of the loaded module using the module's associated debug information produced by the compiler or other methods. The library instruments the identified methods and execution resumes.

Each method in the module is disassembled, and an intermediate representation of the method is constructed. A single pass is made over the instruction stream in order to do this. The disassembler creates a list of the method's basic blocks with each basic block including its list of instructions. If the method does any exception handling (try/catch), there might be additional basic blocks that are not part of the method's contiguous instruction stream. The system identifies these additional basic blocks by detecting common exception handling patterns in the method (e.g., MICROSOFT™ WINDOWS™ x86 code stores exception handler locations using the FS segment register) and inspecting the appropriate exception handler information to determine where the catch handler is located.

Once the method is disassembled, a second pass is made over the method's intermediate representation in order to emit the instrumented version of the method. The runtime library writes its instructions into newly allocated memory. This memory may be allocated within a 2 GB range of the target module's base address. This constraint allows method redirection from the original method to the instrumented method with a single x86 relative jmp instruction, which is limited to a signed 32-bit range (2 GB). Other redirection methods can allow use of wider memory ranges.

The runtime library re-assembles and emits the original instructions; however, probes are also emitted before each basic block or at other locations depending on the purpose of the instrumentation. For block-level code coverage, the probe is a series of instructions that indicate at runtime that a basic block has been executed. The probe writes to a well-known location in memory determined by the basic block's index. Once the instrumented method is written out, some addresses need to be fixed-up. The fix-ups are needed since code has been effectively moved, invalidating some addresses. Any references to basic blocks found in the binary's relocation section (“.reloc” when using the Portable Executable (PE) format for binaries) are updated to point to the basic blocks' new addresses. The addresses to which probes write their data are determined after instrumentation, so these are also fixed-up. Any branches within the method are also fixed-up with new displacements, taking into account the shifting code due to the inserted probes. Any exception handling information discovered during disassembly is also fixed-up as it might refer to addresses within the method.

Near the end of instrumentation, the system overwrites the original method with a jmp or other instruction, redirecting control flow to the instrumented method. Any methods calling the original method are now effectively calling the instrumented version of the method instead. At this point, the body of the original method is no longer needed. Once the module has been completely instrumented, execution proceeds as usual except that it now flows through the basic block probes, providing any specific statistics configured.

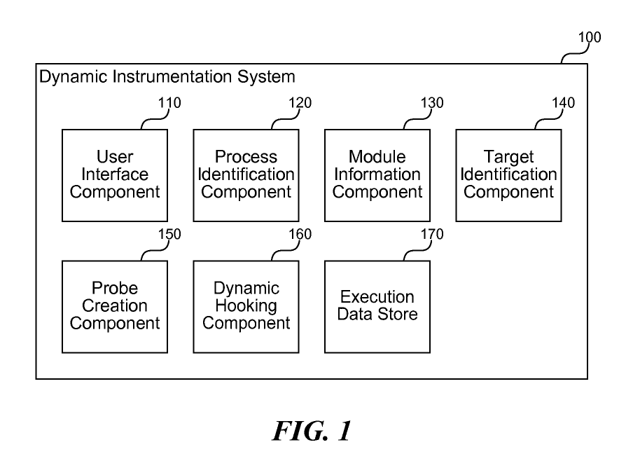

FIG. 1 is a block diagram that illustrates components of the dynamic instrumentation system, in one embodiment. The system 100 includes a user interface component 110, a process identification component 120, a module information component 130, a target identification component 140, a probe creation component 150, a dynamic hooking component 160, and an execution data store 170. Each of these components is described in further detail herein.

The user interface component 110 provides an interface for controlling a software code verification activity and receiving output from the activity. For example, the activity may include performing code coverage analysis on a particular module during a series of test passes, or performance analysis to identify code “hot spots” in a module that may be good targets for optimization, The user interface component 110 may provide a graphical user interface (GUI), console user interface (GUI), programmatic API, or other interface for controlling the activity. In some embodiments, the component 110 may interface with an IDE or other application as a plug-in for that environment.

The process identification component 120 identifies a binary executable module for which a developer wants to perform the code verification activity. For example, the user interface component 110 may provide a file browsing dialog for selecting an application to run using the system 100. The process identification component 120 loads the selected module and creates a suspended process that executes the module. The module may be an EXE file that loads other modules (e.g., DLLs). The process identification component 120 injects a runtime instrumentation library into the created process. The runtime library can perform many types of instrumentation that would be difficult or impossible from outside of the process. Thus, the process identification component 120 injects the library into the processes address space and causes the process to execute the library. For example, the component 120 may modify an import table of the module present in memory in the process to point to the runtime library.

The module information component 130 loads information related to the identified binary module for locating software functions and other locations within the module. For example, the module information component 130 may load a program database (PDB) file or other metadata that includes debugging symbols, module information, and so forth. The software code verification activity implies that certain or all module functions are hooked by the system to capture some statistical information or perform some other action related to the activity. The system 100 uses the module information component 130 to gather information describing locations of interest within the module.

The target identification component 140 identifies one or more target locations within the identified binary module for locating in-memory instrumentation probes. For code coverage, the targets are at each branch location so that the system can track code flow no matter which branch is taken during execution of the process. For performance analysis, the targets may be at the beginning and end of each function so that the system 100 can record the total time spent in each function. Target locations may vary depending on the scope and type of code verification activities for which the system 100 is used, and the specific locations may differ for each activity. However, the module information gathered and the ability to disassemble program locations are sufficient to identify any particular target location for inserting a probe.

The probe creation component 150 allocates memory for storing and creates one or more instrumentation probes. The probe creation component 150 may allocate a block of memory for storing entire copies of instrumented functions so that the system 100 can insert probes at various locations within the original function. The component 150 may also provide small probe stubs for redirecting original execution locations to a new location. There are varieties of ways to hook and manage instrumented code within a process, and the probe creation component 150 creates and stores probes for the particular method being used for any particular code verification activity.

The dynamic hooking component 160 inserts the created probes at the locations identified by the target identification component 140. The dynamic hooking component may copy an original function to the allocated probe area, modify the function with instrumentation, fix-up any address changes caused by the instrumentation, and insert a call or jump to the instrumented code at the original code location. The dynamic hooking component allows the system 100 to modify function calls dynamically within the process to point to new, instrumented versions of the functions. The ability to instrument functions in memory prevents modifying the module stored in persistent storage but provides the same quality of functionality for code verification activities. After the process completes execution, any instrumentation is lost as the process is unloaded from memory. Thus, the persistently stored binary module is unchanged and the instrumentation is valid for the life of the process. In some embodiments, the system 100 caches instrumented functions for faster dynamic instrumentation during future code verification activities. This can improve performance where a code coverage test pass or other activity is run repeatedly on the same module.

The execution data store 170 stores dynamically captured execution information as the selected binary module executes and provides the execution information to the user interface component 110 to provide output from the code verification activity. If the activity is code coverage, then the captured execution information is a Boolean indication of whether each branch in the selected module or related modules was executed during the code coverage test pass. The execution data store 170 may include one or more in-memory data structures, files, cloud-based storage services, or other facilities for storing data captured from program execution.

The computing device on which the dynamic instrumentation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

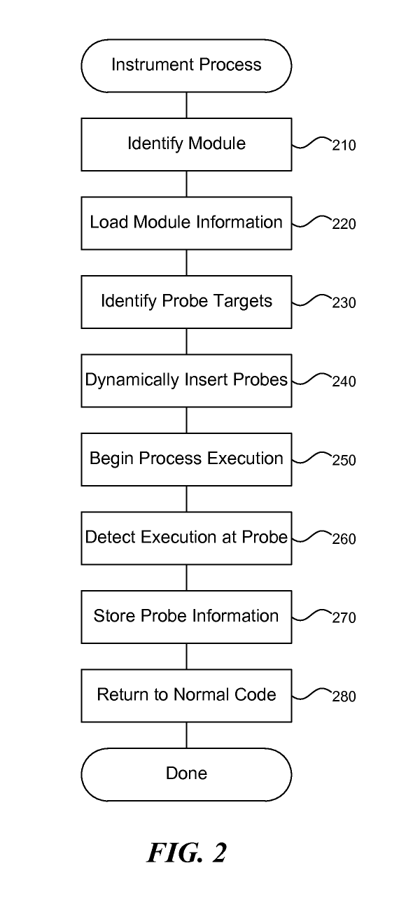

FIG. 2 is a flow diagram that illustrates processing of the dynamic instrumentation system to instrument an executable process dynamically within a runtime library running in the process, in one embodiment. Beginning in block 210, the system identifies a module associated with a process in which the runtime library is executing. For example, the operating system may provide an API or a known memory location that includes process information, including the original command line or module location associated with the process. The system uses the module identification to find module information, such as debug symbols, configuration information for a code verification activity, and so forth. A process is an operating concept that represents a mapping of the executable module into memory, allocation of memory for use by the executing process, and runtime information for managing the process used by the operating system.

Continuing in block 220, the system loads module information that identifies one or more locations within the process at which functions or other code features are located. Common debugging symbol formats, such as PDB files, include information about where each function is located, source code associated with each function, variable names, and other symbolic information that is often lost during the compilation process. This information is often stored separately for debugging purposes but need not be shipped with a particular binary module for it to execute properly. The dynamic instrumentation system uses this information for finding target locations within the process to instrument. The system may include logic for locating and downloading module information from a public or private location.

Continuing in block 230, the system identifies one or more probe target locations within the process. The location of targets varies with the purpose for which the targets are being used, but the target locations form the base of the instrumentation performed on the process. For example, for code coverage, placing probes at each branch location in binary code allows the system to determine which branches execute. A branch can include assembly level jumps, calls, or other instructions that change the code flow (e.g., modify the instruction pointer, eip on x86 architectures).

Continuing in block 240, the system dynamically creates and inserts probes at the identified probe target locations. Dynamically creating and inserting probes may include copying the original program code, instrumenting the code, and redirecting original code locations to the instrumented code. The system may disassemble the original program code to identify locations to instrument and then emit new code with inserted probes. The system may also fix-up any references to code locations that are affected by the instrumentation and movement of the code. For example, many assembly instructions use relative jump addresses that are no longer correct if new instructions are inserted. The system may also process relocation addresses provided by some program module types to modify addresses stored in the instrumented code.

Continuing in block 250, the system begins process execution by allowing the operating system to continue with the normal execution of the process. In some cases, the system starts the process suspended, hooks the load path of the process, and then allows the process to run normally. The system may insert the runtime library into the load path (e.g., as the first import in the import table) so that the operating system loads and initializes the runtime library as part of loading the process. Blocks 210 to 240 occur within the runtime library, and block 250 represents the normal execution of the process after instrumentation has occurred. In some embodiments, blocks 210 to 240 may also occur after block 250. For example, after the process is up and running, the system can load a runtime module dynamically, triggering the instrumentation process described in blocks 210 to 240. Thus, the process may have run some before blocks 210 to 240, received instrumentation through blocks 210 to 240, and then block 250 represents the subsequent execution of the process to perform the normal work of the process.

Continuing in block 260, the system receives execution at a probe location. For example, the probe may insert binary instructions that call a logging or other function to store information describing runtime conditions at the probe iocation. A probe may capture a variety of types of information, such as the time the probe ran, a Boolean indicating that the probe was triggered, execution state of the registers or other locations, and so forth. For example, in a code coverage pass, the probes indicate which code blocks are hit by a test pass and which are not.

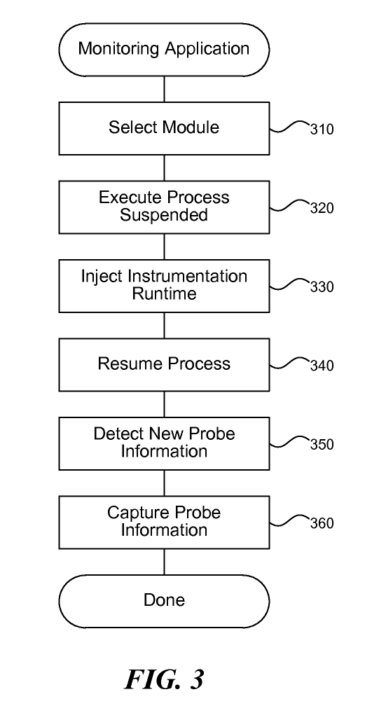

Continuing in block 270, the system stores probe information captured by probe execution. The system may store the information in an in-memory buffer in the application's process, communicate the information to another process via shared memory or named pipes, store the information to disk or other storage, and no forth. The system stores the probe information so that the management process (described further with reference to FIG. 3) can pick up the information and provide it directly to a developer or in an automated code verification report.

Continuing in block 280, the system returns to the original code flow following the probe execution and runs until the next probe is triggered. The probes may insert assembly instructions between the original method's assembly instructions, and when the probe has captured any information, requested execution continues at the next assembly instruction after the probe. The probe may include calling a probe function and returning from that function to the original code location that follows the probe. After block 280, these steps conclude.

FIG. 3 is a flow diagram that illustrates processing of the dynamic instrumentation system to control a dynamic runtime injected in a process for instrumentation through a monitoring application, in one embodiment. Beginning in block 310, the system selects an executable module to execute with dynamic instrumentation to perform a code verification activity. The system may provide a user interface through which a software developer selects an executable module and monitors the execution of the module during the activity. The activity may include code coverage, performance, compatibility, or other analysis. The system runs the module with injected instrumentation so that the code verification activity can occur without statically modifying the stored binary module.

Continuing in block 320, the system creates a process associated with the selected executable and instructs the process to be suspended after the module is loaded. Most operating systems provide an API parameter for creating processes that are initially suspended. Upon request, the operating system will load the selected module, perform certain initialization tasks, create a first thread, and then not schedule the thread to execute until the process is resumed from suspension. Executing the process in a suspended manner allows the monitoring application to inject a runtime library into the process to perform instrumentation before the original code of the process executes.

Continuing in block 330, the system injects an instrumentation runtime library into the created process and modifies the process to cause the library to run. The system may modify the import table of the created process to load the runtime library, create a remote thread in the created process, or perform other steps to cause the runtime library to load and run. Operating systems provide a number of formal and informal ways in which to inject executable code into a process that are well known in the art.

Continuing in block 340, the system resumes the suspended process allowing the process to execute. For example, the system may call the WIN32™ ResumeThread function or another API that causes the operating system to schedule the process for execution. As the process executes, the injected runtime library will instrument the process as described further with reference to FIG. 2.

Continuing in block 350, the system detects stored probe information provided by one or more probes dynamically instrumented into the running process by the injected instrumentation runtime library. The probes may store information in shared memory, via named pipes, over a network connection, via a stored file, and so forth. The monitoring application can detect new information and gather the information for analysis.

Continuing in block 360, the system gathers the detected probe information into the monitoring application for completing of the code verification activity. If the activity is code coverage analysis, and the probe information indicates which branches were taken in the running process, then the monitoring application may compile and display a report to the developer that indicates which areas were covered and which were not. The user interface may provide a drill down into each module, source file, or other subset so that the developer can monitor and modify coverage of particular areas by creating new tests. After block 360, these steps conclude.

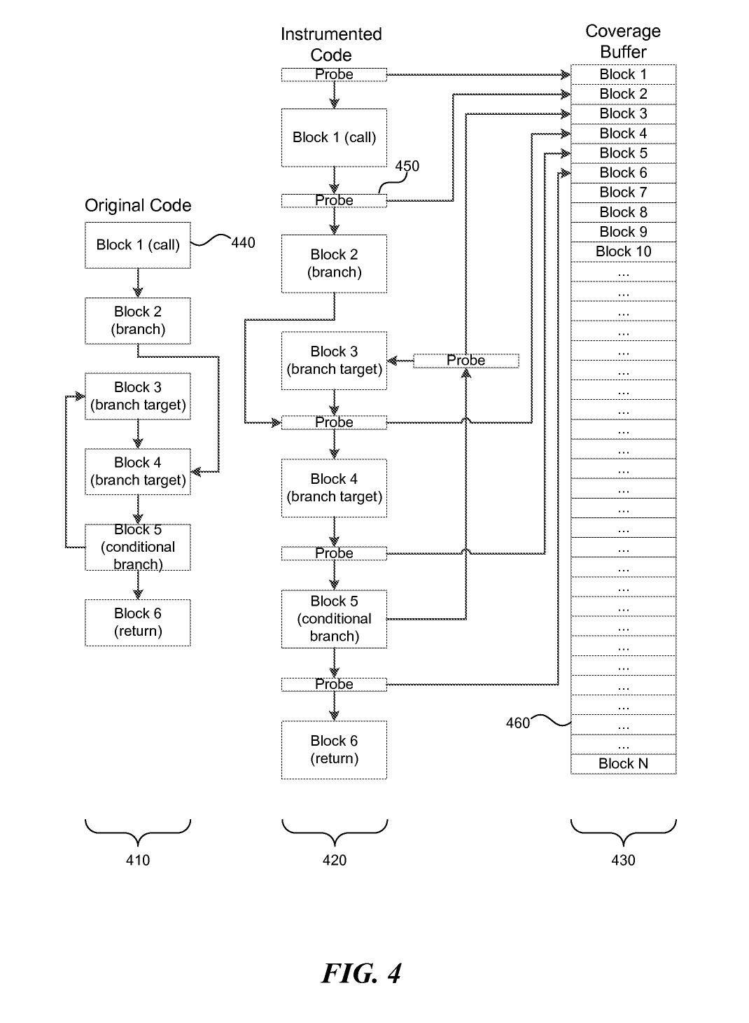

FIG. 4 is a block diagram that illustrates the instrumentation of software code for code coverage by the dynamic instrumentation system, in one embodiment. The diagram includes a flow of original code 410, a flow of instrumented code 420, and a probe data storage area 430. The original code 410 includes one or more blocks 440 that may contain various instructions, including branches that potentially change the program flow if the branch is taken. Executable code on computer processors typically continues from one instruction to the next unless something interrupts the flow, such as a branch based on a condition that changes the flow to a new location. For code coverage, it is typically the goal to know which blocks of code are entered by a particular test pass, so that tests can be designed that exercise each part of the code. If a block is indicated as not entered, a tester can design a test to exercise that block of code.

The instrumented code 420 includes one or more probes 450 inserted between the blocks of the original code 410. The probe may be one or more instructions that notate that a path has been covered or perform other purposes. For code coverage, the system can store which probes have been triggered in a probe data storage area 430 that includes one or more blocks 460 with a Boolean or other value indicating whether (and perhaps how many times) a particular block is executed. The probe data storage area 430 may be in a region of shared memory or may be otherwise communicated to a monitoring application for review by the developer.

In some embodiments, the dynamic instrumentation system provides support for unhooking or rendering instrumentation code benign. For some processes, it is undesirable to end the process. For example, in a data center it may be helpful to instrument a process to get information, then stop gathering information without interrupting user interaction with the process. Thus, the system may allow probes to be removed or may simply cause the probes to perform no operation to allow the process to continue running without gathering instrumentation information. In some cases the probes may be turned on and off from a monitoring application as they are needed. The system may also allow attachment to a running process for similar cases where a process is already running and instrumentation is desirable. The system may suspend the process to perform the instrumentation or use thread safe practices to insert instrumented methods while the code is executing.

From the foregoing, it will be appreciated that specific embodiments of the dynamic instrumentation system have been described herein for purposes of illustration, but that various modifications may be made without deviating from the spirit and scope of the invention. Accordingly, the invention is not limited except as by the appended claims.

I/We claim:

1. A computer-implemented method for instrumenting an executable process dynamically within a runtime library running in the process, the method comprising:
identifying a module associated with a process in which the runtime library is executing;
loading module information that identifies one or more locations within the process at which functions or other code features are located;
identifying one or more probe target locations within the process;
dynamically creating and inserting probes at the identified probe target locations;
beginning process execution by allowing the operating system to continue with the normal execution of the process;
detecting execution at a probe location;
storing probe information captured by probe execution, wherein the preceding steps are performed by at least one processor.

2. The method of claim 1 wherein identifying the module comprises invoking an operation system application programming interface (API) to obtain process information.

3. The method of claim 1 wherein identifying the module comprises using the module identification to find module information, including debug symbols.

4. The method of claim 1 wherein loading module information comprises accessing information that identifies address locations of each function in the module.

5. The method of claim 1 wherein identifying probe target locations comprises locating one or more branch locations in binary code for placing probes.

6. The method of claim 1 wherein identifying probe target locations comprises disassembling the code and identifying one or more assembly instructions that modify a flow of the code.

7. The method of claim 1 wherein dynamically creating and inserting probes includes copying the original program code, instrumenting the code, and redirecting original code locations to the instrumented code.

8. The method of claim 1 wherein dynamically creating and inserting probes comprises instrumenting the code in-memory without modifying the stored module.

9. The method of claim 1 wherein dynamically creating and inserting probes comprises fixing up any references to code locations that are affected by the instrumentation and movement of the code.

10. The method of claim 1 wherein beginning process execution comprises resuming a previously suspended thread of the process.

11. The method of claim 1 wherein detecting execution at the probe location comprises detecting execution of probe instructions that call a logging or other function to store information describing runtime conditions at the probe location.

12. The method of claim 1 wherein storing probe information comprises storing the information in a shared-memory buffer accessible by a monitoring application associated with the runtime library.

13. A computer system for dynamically instrumenting software code in memory, the system comprising:
a processor and memory configured to execute software instructions embodied within the following components;
a user interface component that provides an interface for controlling a software code verification activity and receiving output from the activity;
a process identification component that identifies a binary executable module for which to perform the code verification activity;
a module information component that loads information related to the identified binary module for locating software functions and other locations within the module;
a target identification component that identifies one or more target locations within the identified binary module for locating in-memory instrumentation probes;
a probe creation component that allocates memory for storing and creates one or more instrumentation probes; and
a dynamic hooking component that inserts the created probes at the locations identified by the target identification component.

14. The system of claim 13 wherein the code verification activity comprises determining code coverage or assessing code performance.

15. The system of claim 13 wherein the process identification component loads the selected module, creates a suspended process that executes the module, and injects a runtime instrumentation library into the created process.

16. The system of claim 13 wherein the target identification component accesses debugging symbols and disassembles identified code locations to determine where to place instrumentation probes.

17. The system of claim 13 wherein the probe creation component allocates a block of memory for storing copies of instrumented functions so that the system can insert probes at various locations within a copy of an original function.

18. The system of claim 13 wherein the probe creation component provides small probe stubs for redirecting original execution locations to an instrumented location.

19. The system of claim 13 wherein the dynamic hooking component copies an original function to the allocated probe area, modifies the function with instrumentation, fixes up any address changes caused by the instrumentation, and inserts a jump to the instrumented code at the original code location.

20. A computer-readable storage medium comprising instructions for controlling a computer system to control a dynamic runtime injected in a process for instrumentation through a monitoring application, wherein the instructions, upon execution, cause a processor to perform actions comprising:
selecting a module to execute with dynamic instrumentation to perform a code verification activity;
creating a process associated with the selected module and instructing the process to be suspended after the module is loaded;
injecting an instrumentation runtime library into the created process and modifying the process to cause the library to run;
resuming the suspended process allowing the process to execute;
detecting stored probe information provided by one or more probes dynamically instrumented into the running process by the injected instrumentation runtime library; and
gathering the detected probe information into the monitoring application completing of the code verification activity.
